(19) United States
(12) Patent Application Publication
(10) Pub. No.: US 2005/0259812 A1
(43) Pub. Date: Nov. 24, 2005

(54) Bluetooth communication assembly

(76) Inventor: I-Ming Chen, Taipei (TW)

Correspondence Address: BIRCH STEWART KOLASCH & BIRCH, PO BOX 747, FALLS CHURCH, VA, 22040-0747, US

(21) Appl. No.: 10/847,465

(22) Filed: May 18, 2004

(51) Int. Cl. H04M 1/00; H04M 9/00

(52) U.S. Cl. 379/431

(57) ABSTRACT

A communication assembly includes a body having a socket and a circular projection formed around the socket, and an ear set having a terminal formed on a first distal end of the ear set to correspond to the socket, an arcuate cap formed around the terminal to be inserted into the circular projection, a microphone formed on a second distal end of the ear set and an earphone rotatably mounted on the ear set.

### BACKGROUND OF THE INVENTION

1. Field of the Invention

The present invention relates to a communication assembly, and more particularly to a communication assembly using bluetooth as the communication technique.

2. Description of Related Art

Infrared communication is the most widely used technique in the communication field and becomes the standard equipment for notebook computers. However, infrared communication suffers drawbacks. When the infrared communication technique is applied, there should be no barrier in-between or the communication fails. Furthermore, the two objects using infrared technique to communication with each other should be in alignment (Line Of Sight) so that the infrared communication is able to have a successful transmission between the two objects. Other drawback is that the infrared communication allows only the communication between two objects. Safety is another concern when the infrared transmission is employed. Bluetooth communication is a technique used in short distance transmission between two objects and has penetration capability to penetrate any barrier between the two objects should there be a barrier positioned between the two objects. Furthermore, there is no requirement to align the two objects when the bluetooth technique is applied. Also, equipment with the bluetooth function is able to connect to other equipment with bluetooth function to form a so-called “Piconet”. In comparison, it is noted that the bluetooth technique is far better than the infrared technique.

However, the current ear set using the bluetooth as the transmission function has the following disadvantages: (a) heavy weight, weight problem being long the main reason that makes a wearer uncomfortable; (b) fixed structure between the earphone and the body, the fixed structure causing the breakage of the earphone from the body; and (c) large volume of the body, because the body of the ear set is large, the wearer often feels pressure in the ear and sometimes causes uncomfortable.

To overcome the shortcomings, the present invention intends to provide an improved communication assembly to mitigate the aforementioned problems.

### SUMMARY OF THE INVENTION

The primary objective of the invention is to provide an improved communication assembly using bluetooth as the transmission technique and having advantages of lightweight and compact.

Another objective of the invention is that the communication assembly has a body, an earphone, and a microphone.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of the communication assembly of the present invention;

FIG. 2 is an exploded perspective of the communication assembly of FIG. 1;

FIG. 3 is a perspective view of the body of the communication assembly of the present invention;

FIG. 4 is a perspective view of the ear set of the communication assembly of the present invention;

FIG. 5 is a perspective view showing that the microphone is rotated relative to the ear set; and

FIGS. 6, 7 and 8 are schematic views showing the application of the communication assembly of the present invention.

### DETAILED DESCRIPTION OF PREFERRED EMBODIMENT

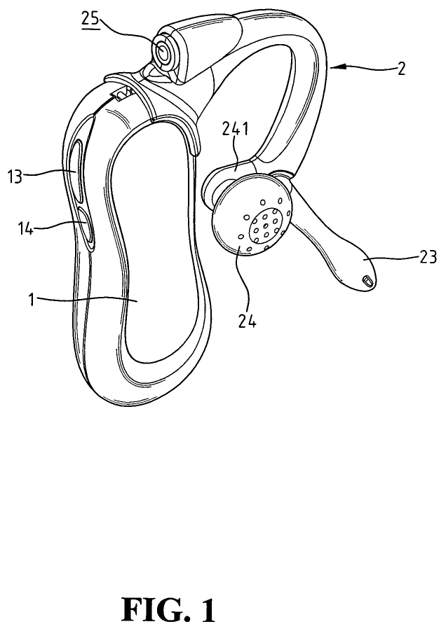

With reference to FIG. 1, a communication assembly in accordance with the present invention includes a body 1, an ear set 2, and a microphone 3.

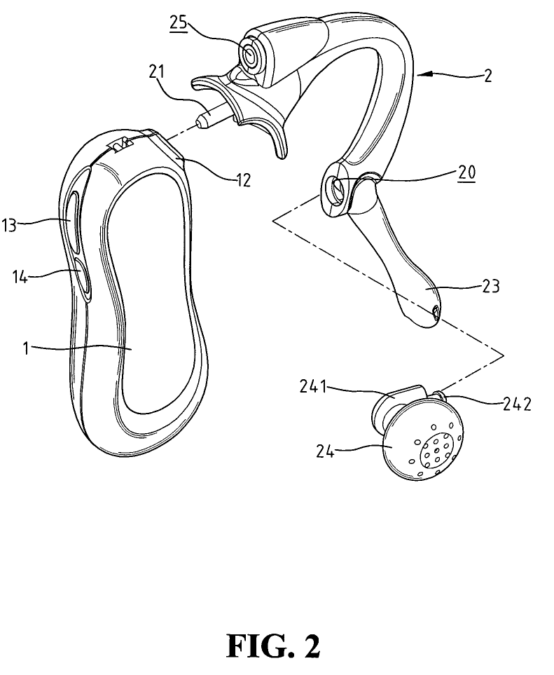

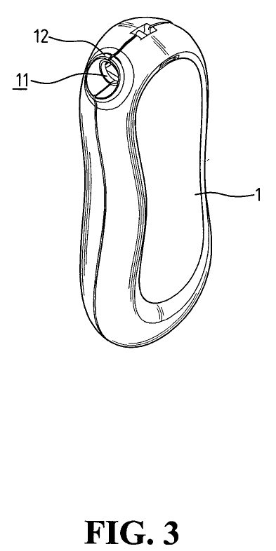

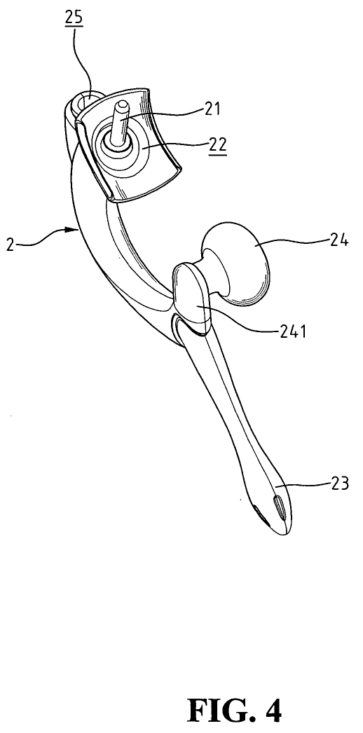

With reference to FIGS. 2, 3 and 4, the body 1 has a recessed central portion to correspond to the shape of a human ear, a socket 11 defined in the body 1 and a circular projection 12 formed around the socket 11 and a control button 13 on a side of the body.

The ear set 2 is arcuate and has a terminal 21 formed on a distal end thereof, an arcuate cap 22 formed around the terminal 21 to correspond to the circular projection 12 of the body 1, a microphone 23 is formed on the other end of the ear set 2 and an earphone 24. A terminal hole 25 may be provided on the ear set 2. The earphone 34 is provided with a base 241 formed on a rear face thereof and a connection rod 242 extending out from the base 241 to correspond to a connection hole 20 of the ear set 2.

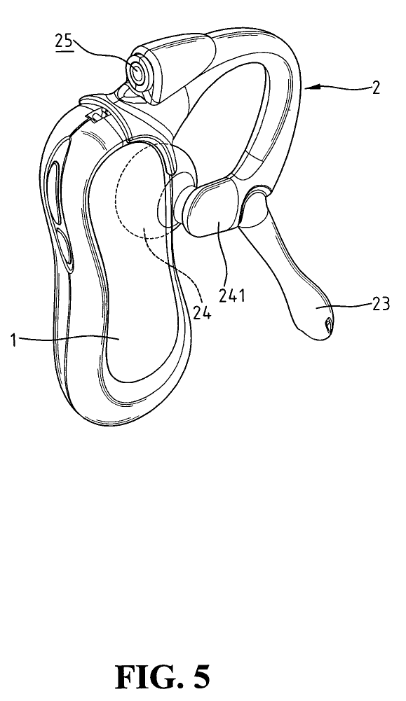

With reference to FIG. 5, it is noted that when the communication assembly of the present invention is in assembled, the terminal 21 is inserted into the corresponding socket 11 of the body 1 and the arcuate cap 22 is inserted into the circular projection 12 to secure the engagement between the body 1 and the ear set 2 and ensure the electrical connection therebetween. The connection rod 242 of the microphone 24 can be inserted into the connection hole 20 of the ear set 2 to secure the engagement between the ear set 2 and the microphone 24. Furthermore, due to the connection between the ear set 2 and the microphone 24 is based on the connection between the connection rod 242 and the connection hole 20, the microphone 24 is able to rotate relative to the ear set 2 to meet different user's requirements.

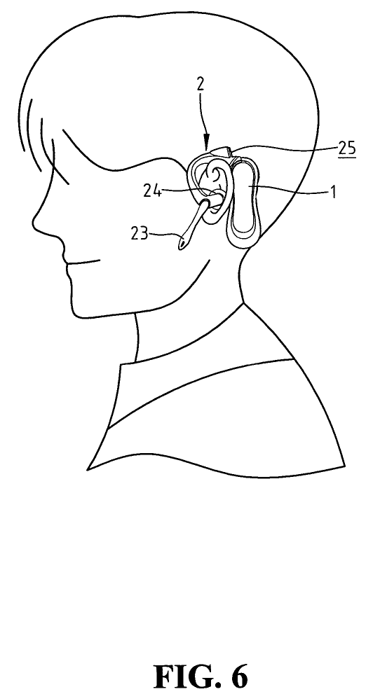

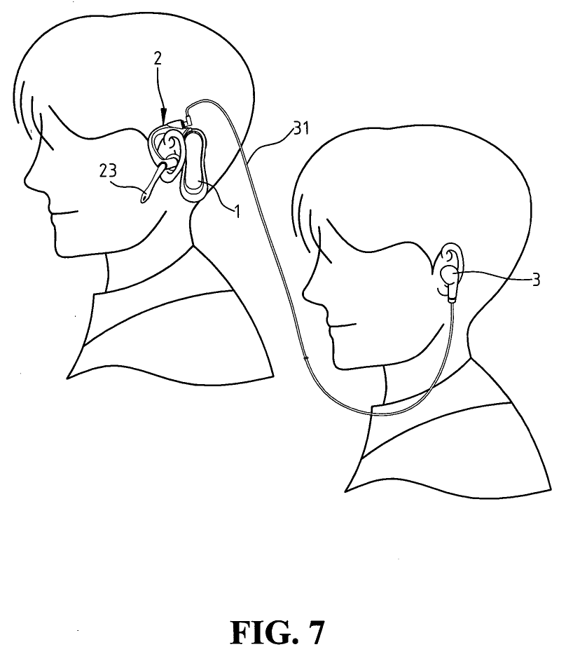

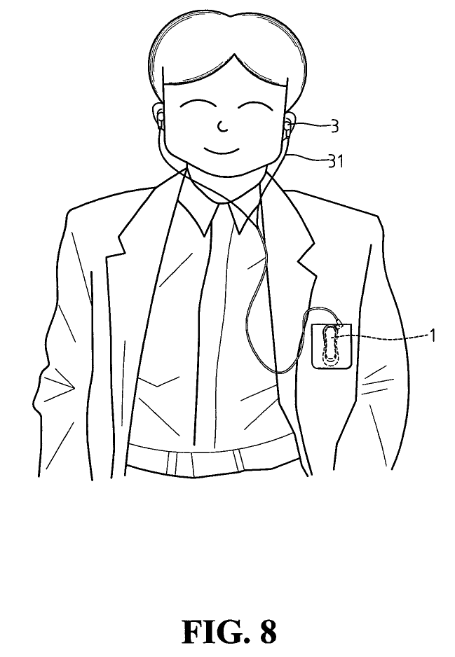

With reference to FIGS. 6, 7 and 8, it is noted that when the communication assembly of the present invention is in application, a second earphone 3 is able to connect to the ear set 2 by inserting the second terminal (not shown) into the terminal hole 25 to allow a second user to listen to the message simultaneously. Also, the user may use both the earphones 24, 3 to have a stereo effect. Again, the user may use the body 1 and the earphones only function as a Walkman.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A communication assembly comprising:
a body having a socket and a circular projection formed around the socket; and
an ear set having a terminal formed on a first distal end of the ear set to correspond to the socket, an arcuate cap formed around the terminal to be inserted into the circular projection, a microphone formed on a second distal end of the ear set and an earphone rotatably mounted on the ear set.

2. The communication assembly as claimed in claim 1, wherein the body has a recessed central portion.

3. The communication assembly as claimed in claim 1, wherein the earphone has a base with a connection rod to correspond to a connection hole defined in the ear set such that after the connection rod is inserted into the connection hole, the earphone is able to rotate relative to the ear set.

4. The communication assembly as claimed in claim 2, wherein the earphone has a base with a connection rod to correspond to a connection hole defined in the ear set such that after the connection rod is inserted into the connection hole, the earphone is able to rotate relative to the ear set.

5. A communication assembly comprising:
a body having a socket and a terminal hole defined in the body; and
two earphones respectively insertable into the socket and the terminal hole.
